(19) United States
(12) Patent Application Publication
(10) Pub. No.: US 2025/0050768 A1
(43) Pub. Date: Feb. 13, 2025

(54) ELECTRIC VEHICLE SUPPLY EQUIPMENT MEDIA ACCESS CONTROL ADDRESS MAPPING

(71) Applicant: Ford Global Technologies, LLC, Dearborn, MI (US)

(72) Inventors: Stan Bradbury, Saline, MI (US); Micah Kaiser, Clinton Township, MI (US); Jeffrey Hu, Ann Arbor, MI (US)

(21) Appl. No.: 18/446,809

(22) Filed: Aug. 9, 2023

(51) Int. Cl. B60L 53/30; H02J 7/00

(52) U.S. Cl. CPC B60L 53/305; H02J 7/00032; H04L 61/50; H04L 2101/622

(57) ABSTRACT

Systems and methods for automating delivery of electric charge to a vehicle are described. In one example, a media access control address is mapped, related, or associated with an EVSEID at each location so that a cloud server may request activation of the electric vehicle supply equipment.

### FIELD

The present description relates to a method and system for charging an electric vehicle.

### BACKGROUND

An electric machine may stop at a public charging station from time to time to refill a traction battery. Some public charging devices (aka “chargers”), also known as electric vehicle supply equipment (EVSE), may be configured to “Plug & Charge” a vehicle. Plug & Charge may allow a vehicle operator to plug a vehicle into a charger and begin charging the vehicle without offering a credit card, app, or other form of payment. While “Plug & Charge” may be a desirable way to charge an electric vehicle, many EVSE do not support the “Plug & Charge” operating standards. Therefore, vehicles may not experience the benefits of “Plug & Charge” at some EVSE.

Public charge management services (CMS), an aggregator of EVSE operated by charge point operators (CPO) that automatically bills for charging services and activates EVSE use an open charge point interface (OCPI) standard to provide unique identities for geographic locations (LocationID) and individual EVSE (EVSEID), but this service does not provide an actual unique media access control (MAC) address for each EVSE via OCPI. A vehicle receiving charge at an direct current fast charger (DCFC) EVSE that is operated by CMS receives a MAC address for the EVSE during a signal level attenuation characterization (SLAC) (e.g., a communication sequence initialization procedure in which EVSE notifies a vehicle it is present and the vehicle notifies the EVSE that the vehicle is present at the EVSE), but the MAC address is not associated with a LocationID or EVSEID that is used to activate the public charger via a remote charging start request that is sent to the CMS. Therefore, a vehicle cannot identify which EVSE it would like to receive charge from and be billed for charging services. As such, the vehicle cannot initiate a charging start request to the CMS solely based on the EVSE MAC address received.

Some EVSE may also be unable to supply charge from time to time due to lack of maintenance, power disruptions, and/or degradation of EVSE components. If EVSE degradation occurs while a vehicle is being charged, the EVSE may supply data to the vehicle that indicates why the EVSE may no longer be able to supply charge. The vehicle may know the EVSE MAC address of a degraded charger, but not the LocationID or the EVSEID. Therefore, the vehicle may not be able make other vehicles aware that the EVSE is not presently able to supply charge or is experiencing reliability issues even though the CPO is reporting the charger in good standing via OCPI. As such, some vehicles may be inadvertently routed to an EVSE that may not be able to supply charge, are difficult to activate or perform in a less than desirable way.

The inventors herein have recognized the above-mentioned issues and have developed a method for charging a traction battery, comprising: generating a relationship between a media access control address value and a location identification value; and activating an electric vehicle supply equipment via referencing the relationship according to the media access control address value.

By generating a relationship between a media access control address value and a location identification value, it may be possible to plug a vehicle into an EVSE device (e.g., direct current (DC) fast charger that supplies DC electric power to an electric vehicle) and begin charging without having to produce a credit card or other monetary payment device. Thus, a vehicle operator may simply plug and charge an electric vehicle at any DC fast charger irrespective of whether or not it supports the ISO 15118 Plug & Charge standard.

The present description may provide several advantages. In particular, the approach may benefit a vehicle charging experience. Further, the approach may provide several ways to register and activate at a higher percent of EVSE devices so that they may be automatically activated in response to plugging a vehicle in to an EVSE device. The approach also enables a cloud to rate the reliability and performance of each individual chargers so users may plug into the best EVSE equipment and have the highest change of charging success. Additionally, the approach may function even in the presence of MAC address changes.

The above advantages and other advantages, and features of the present description will be readily apparent from the following Detailed Description when taken alone or in connection with the accompanying drawings.

The summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of a vehicle that includes an electric energy storage device and an electric machine for propulsion;

FIG. 2 is a block diagram showing event based mapping of EVSE MAC address to public EVSE LocationID/EVSEID;

FIG. 3 is a block diagram showing time based mapping of EVSE MAC address to public EVSE LocationID/EVSEID;

FIG. 4 is a flowchart of a method for event based mapping of EVSE MAC address to public EVSE LocationID/EVSEID;

FIG. 5 is a flowchart of a method for event based mapping of time based mapping of EVSE MAC address to public EVSE LocationID/EVSEID; and

FIG. 6 is a block diagram showing a Plug & Activate feature.

### DETAILED DESCRIPTION

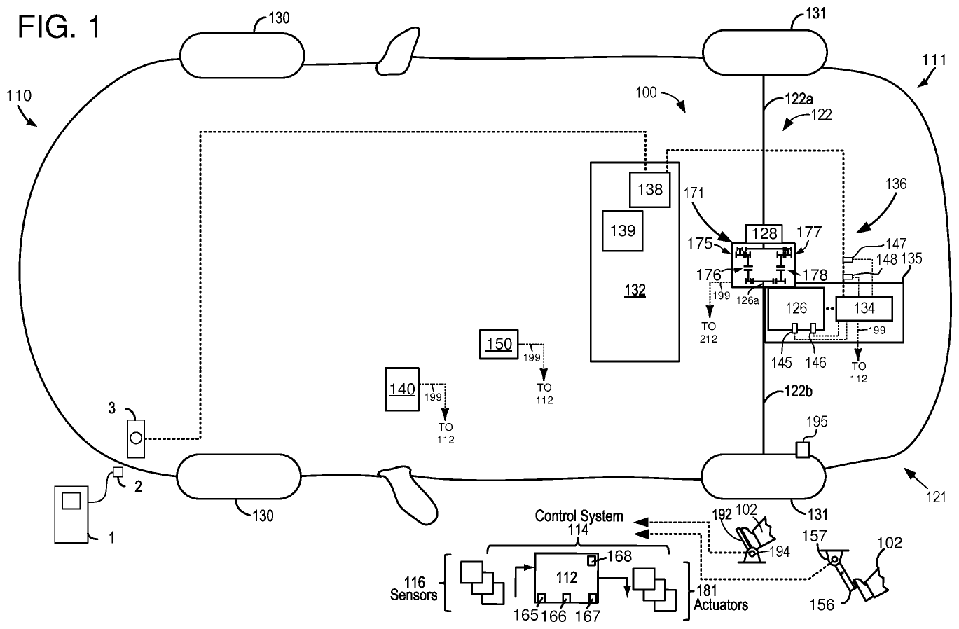

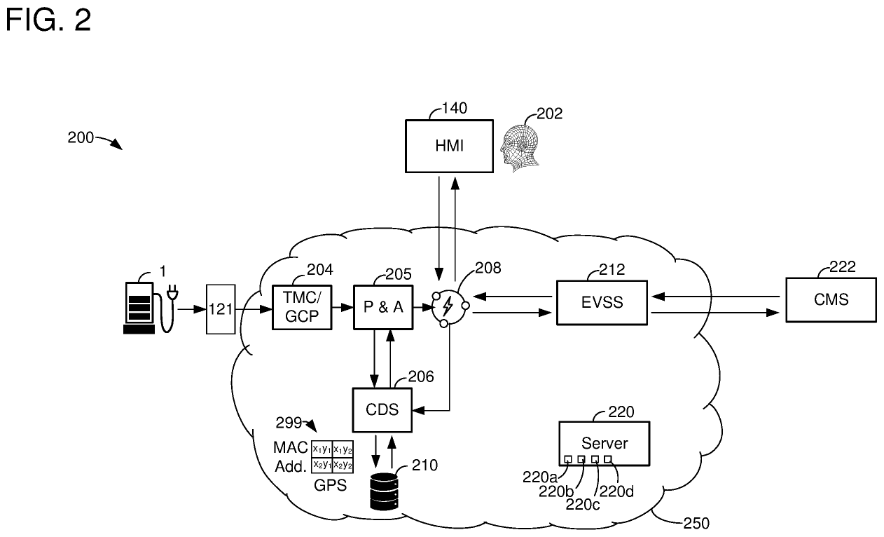

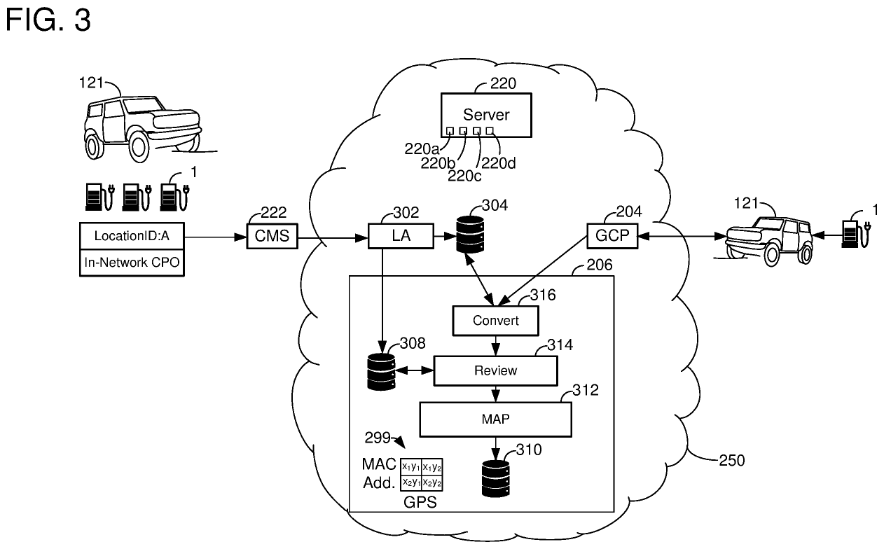

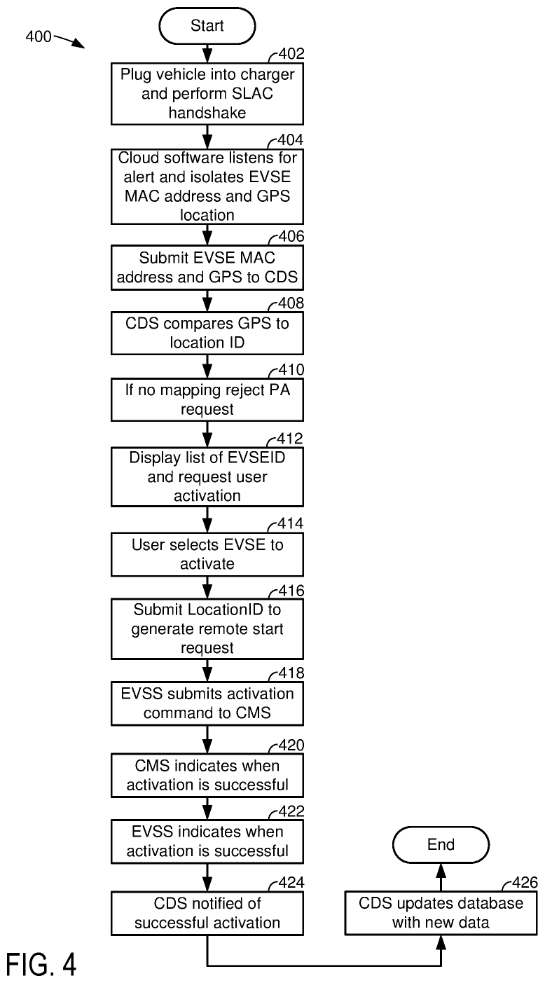

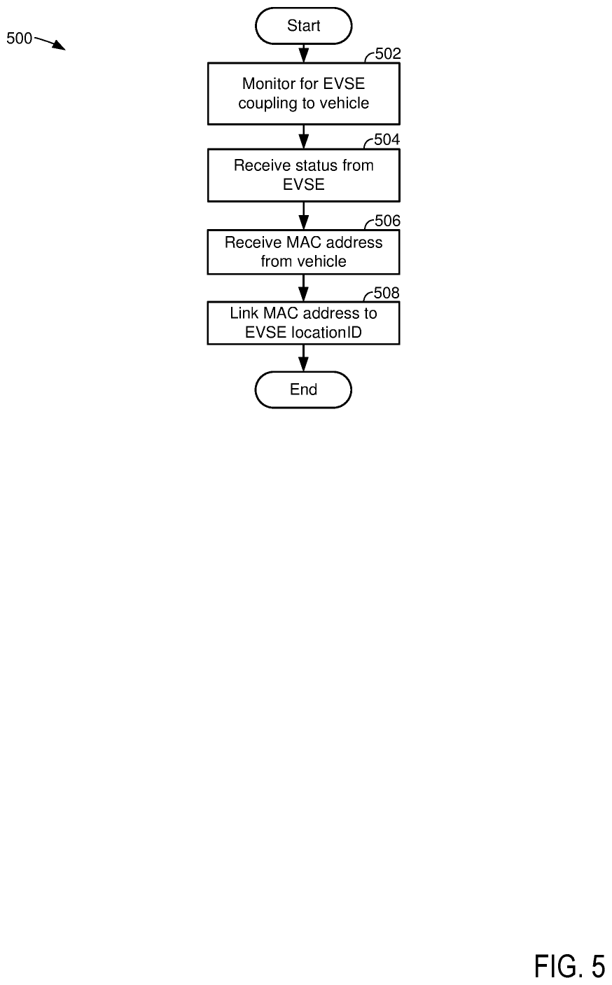

The present description is related to systems and methods for managing vehicle charging. The systems and methods may allow a vehicle to receive charge and billing from an EVSE network without an operator using credit card or software application (app). The vehicle may be an electric vehicle of the type shown in FIG. 1. FIGS. 2 and 3 show block diagrams for mapping EVSE MAC addresses (e.g., 12 digit hexadecimal number, with the numbers separated every two digits by a colon or hyphen) to enable simplified vehicle charging and charging performance metrics by each LocationID/EVSEID. FIGS. 4 and 5 show flowcharts of methods for mapping EVSE MAC addresses.

FIG. 1 is a schematic diagram of a vehicle 121 including a powertrain or vehicle propulsion system 100. A front portion of vehicle 121 is indicated at 110 and a rear portion of vehicle 121 is indicated at 111. Vehicle propulsion system 100 includes electric machine 126. Electric machine 126 may consume or generate electrical power depending on its operating mode. Throughout FIG. 1, mechanical connections between various components are illustrated as solid lines, whereas electrical connections between various components are illustrated as dashed lines.

Vehicle propulsion system 100 has a rear axle 122. In some examples, rear axle 122 may comprise two half shafts, for example first half shaft 122a, and second half shaft 122b. Vehicle propulsion system 100 further has front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a gearbox 171 including a low gear 175 and a high gear 177 that are coupled to electric machine 126 via output shaft 126a of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over controller area network (CAN) 199. Alternatively, high gear clutch 178 and low gear clutch 176 may be opened and closed via digital outputs or pulse widths provided via control system 114. Rear drive unit 136 may include differential 128 so that torque may be provided to first half shaft 122a and to second half shaft 122b. In some examples, an electrically controlled differential clutch (not shown) may be included in rear drive unit 136.

Electric machine 126 may receive electrical power from onboard electrical energy storage device 132. Furthermore, electric machine 126 may provide a generator function to convert the vehicle's kinetic energy into electrical energy, where the electrical energy may be stored at electric energy storage device 132 for later use by electric machine 126. An inverter system controller (ISC) 134 may convert alternating current generated by electric machine 126 to direct current for storage at the electric energy storage device 132 and vice versa. Electric drive system 135 includes electric machine 126 and inverter system controller 134. Inverter system controller may include a microcontroller, memory (e.g., random-access memory and read-only memory), and input/output circuitry (not shown). Electric energy storage device 132 may be a battery (e.g., a traction battery that provides energy to propel a vehicle), capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

Control system 114 may communicate with electric machine 126, energy storage device 132, inverter system controller 134, etc. Control system 114 may receive sensory feedback information from electric drive system 135 and energy storage device 132, etc. Further, control system 114 may send control signals to electric drive system 135 and energy storage device 132, etc., responsive to this sensory feedback. Control system 114 may receive an indication of an operator requested output of the vehicle propulsion system from a human operator 102, or an autonomous controller. For example, control system 114 may receive sensory feedback from driver demand pedal position sensor 194 which communicates with driver demand pedal 192. Pedal 192 may refer schematically to a driver demand pedal. Similarly, control system 114 may receive an indication of an operator requested vehicle braking via a human operator 102, or an autonomous controller. For example, control system 114 may receive sensory feedback from brake pedal position sensor 157 which communicates with brake pedal 156.

Energy storage device 132 may periodically receive electrical energy from a power source such as fast charging station 1 that is electrically coupled to a stationary power grid (not shown) residing external to the vehicle (e.g., not part of the vehicle). As a non-limiting example, vehicle propulsion system 100 may be configured as a plug-in electric vehicle (EV), whereby electrical energy may be supplied to electric energy storage device 132 via the fast charging station 1 and the power grid (not shown). The fast charging station may be electrically coupled to a vehicle receptacle 3 via a plug 2. The receptacle 3 may be electrically coupled to the electric energy storage device 132.

Electric energy storage device 132 includes an electric energy storage device controller 139 and a power distribution module 138. Electric energy storage device controller 139 may provide charge balancing between energy storage element (e.g., battery cells) and communication with other vehicle controllers (e.g., controller 112). Power distribution module 138 controls flow of power into and out of electric energy storage device 132.

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 195, etc. In some examples, sensors associated with electric machine 126, wheel speed sensor 195, etc., may communicate information to controller 112, regarding various states of electric machine operation. Controller 112 includes non-transitory (e.g., read only memory) 165, random access memory 166, digital inputs/outputs 168, and a microcontroller 167. Controller 112 may receive input data and provide data to human/machine interface 140 via CAN 199. Controller 112 may be a controller that is additional to inverter system controller 134, or alternatively, it may be a controller that is part of inverter system controller 134. Controller 112 may receive vehicle navigation and travel route data (e.g., travel distance, start of travel location, end of travel location, direct current fast charge (DCFC) station locations, road grades, geographical data, etc.) from global position system (GPS) navigation system 150.

Referring now to FIG. 2, a block diagram 200 including a cloud based traction battery charging approach is shown. Cloud 250 of the cloud based charging approach may be comprised hardware and of a plurality of software modules including a transportation mobility cloud aggregation service 204 (e.g., a software module that aggregates electric vehicle charger MAC addresses and GPS locations), a Plug & Activate software feature 205 that facilitates automated vehicle charging, a charger data service 206 module that stores a mapping that associates a particular MAC address with a particular LocationID and EVSEID, storage media 210 including a database mapping or relationship of MAC address and GPS position to LocationID and EVSEID 299, charge assist software module 208 for assisting a user to charge the EV (e.g., providing locations of EVSE to a user, etc.), and electric vehicle supply electric vehicle specific services 212 (e.g., services that are specific to EVs, such as requests to charge the EV, requests to find EV charging stations, etc.). Cloud 250 may interface with EVSE 1 via vehicle 121, vehicle human/machine interface (HMI) 140, and charge management services 222. Charge management service (CMS) 222 may selectively activate EVSE 1 also provide electronic billing services to receive monetary compensation for supplying electric charge to a vehicle 121. CMS 22 is external to the EV and it may be linked to a plurality of EVSE. Human 202 may provide input to HMI 140. Hardware for cloud 250 may be comprised of a server 220 (computer) including core or processor 220a, memory 220b (e.g., random-access, read-only, keep-alive, etc.), analog and digital inputs and outputs 220c, and communications ports 220d.

In one example, the mapping or relationship at 299 may be referenced or indexed by GPS position and MAC address. The mapping or relationship 299 outputs a LocationID (indicated as an x) and an EVSEID (indicated as y).

Referring now to FIG. 3, a block diagram 300 for time-based mapping of EVSE MAC address to a LocationID/EVSEID is shown. The time-based mapping approach includes the EVSE 1, CMS 222, an EVSE location aggregator 302, transportation mobility cloud aggregation service 204, and CDS 206. The time-based mapping approach monitors EVSE status and time stamps from EVSE and to time stamps of vehicle alerts with GPS and MAC address data. The time-based mapping method correlates plug-in and unplug time stamps of vehicle alerts to EVSE status changes that have nearly matching time stamps to generate a relationship between MAC address of an EVSE and a LocationID/EVSEID 299 that was previously activated.

The CDS may convert a vehicle alert GPS location indication to a LocationID. The CDS may also determine which EVSE at the LocationID activated at the time the vehicle plugged into the EVSE at the LocationID to determine the EVSEID. The EVSE MAC address may be linked or mapped to the LocationID and the EVSEID according to the in-use status data that was submitted by the EVSE to the CMS.

The system of FIGS. 1-4 provides for a system, comprising: a cloud server configured to communicate with a vehicle, an electric vehicle supply equipment, and an external charge management service, the cloud server including executable instructions that cause the cloud server to: generate a relationship between a media access control address, a location identification value, and an electric vehicle supply equipment identification value; and request activation of electric vehicle supply equipment according to the relationship between the media access control address, the location identification value, and the electric vehicle supply equipment identification value. In a first example, the system where the location identification value identifies a unique geographical location of electric vehicle supply equipment. In a second example that may include the first example, the system includes where the electric vehicle supply equipment identification value identifies an individual electric vehicle supply equipment device at the unique geographical location. In a third example that may include one or both of the first and second examples, the system further comprises an in-vehicle human/machine interface and additional executable instructions to supply data to the in-vehicle human/machine interface so that the location identification value and the electric vehicle supply equipment identification value may be determined according to a user selection. In a fourth example that may include one or more of the first through third examples, the system further comprises additional executable instructions that cause the cloud server to update the relationship in response to the media access control address not being associated with location identification value. In a fifth example that may include one or more of the first through fourth examples, the system includes where the relationship is updated in response to an indication that charge is being supplied to the vehicle. In a sixth example that may include one or more of the first through fifth examples, the system includes where activation is requested via sending a message from the cloud server to a charge management service.

Referring now to FIG. 4, a flowchart of a method for event-based mapping of EVSE MAC addresses to LocationID/EVSEID is shown. The method of FIG. 5 may be at least partially implemented as executable instructions stored in controller memory in one or more of the controllers and/or cloud components of FIGS. 1 and 2. Further, the method of FIG. 4 may include actions taken in the physical world to transform operating states of one or more of the systems of FIGS. 1 and 2.

At 402, upon a vehicle being electrically coupled or plugged into EVSE, the vehicle performs a SLAC handshake (e.g., initiates communication via electric signals) with the EVSE. The SLAC handshake may include signaling the EVSE that a vehicle is present and electrically coupled to the EVSE. The EVSE may also send a signal to the vehicle to let the vehicle know that the EVSE is present. The EVSE may also send a MAC address of the EVSE to the vehicle. The vehicle determines the location of the vehicle via the vehicle's GPS system and the vehicle sends an alert to the cloud. The alert includes the MAC address of the EVSE and the present GPS coordinates for the location of the vehicle. The alert may be sent via a cellular phone network or a satellite link that is coupled to the internet. Method 400 proceeds to 404.

At 404, the cloud server listens for an alert that is sent via a vehicle and communicated via the internet. The cloud isolates the EVSE MAC address and the GPS coordinates of the vehicle location from data that is communicated between the vehicle and the cloud server. In other words, the EVSE MAC address and GPS coordinates are removed from the data communicated between the vehicle and the cloud server so that the plug and activate method described herein may be performed. Method 400 proceeds to 406.

At 406, method 400 submits the EVSE MAC address and the GPS coordinates for the vehicle to the CDS. The Plug & Activate feature may make the submission. The CDS stores in a database a mapping of the EVSE MAC addresses to LocationID and EVSEID. The LocationID identifies a geographic location of where charging services may be provided and the EVSEID identifies a particular charger or ESVE at the geographic location. Each LocationID includes an associated GPS location to identify a particular geographic location where the EVSE are located. In other words, the mapping may associate a unique EVSE MAC address with a unique LocationID and EVSEID so that an EVSE with the MAC address may be activated to enable traction battery charging by activating the EVSE according to the LocationID and EVSEID. Thus, the CDS provides a linkage between EVSE MAC address and the EVSE identifiers (e.g., the LocationID and the EVSEID) so that a particular LocationID and EVSEID may be determined from the EVSE MAC address, thereby allowing the EVSE at the LocationID and EVSEID to be activated when the EVSE does not conform to plug and charge standards. Method 400 proceeds to 408.

At 408, the CDS compares the GPS coordinates of the vehicle to the GPS coordinates associated with LocationIDs that are stored in a database. The comparison may be used to determine if the GPS location of the vehicle matches a GPS location at a particular LocationID of an EVSE. If the GPS location is not new (e.g., the GPS location already is included in the CDS database), then the EVSE MAC address is compared against known mappings for EVSEIDs at the LocationID. The particular EVSE that is being requested to provide charge may be activated according to the mapping that is stored in the database when the GPS location is not new. Method 400 proceeds to 410.

At 410, if there is no mapping between the EVSE MAC address and the LocationID/EVSEID, the CDS rejects the automatic vehicle charging request. The CDS may send the rejection to the Plug & Activate feature. If there is a mapping between the EVSE MAC address and the LocationID/EVSEID, method 400 generates a request to activate the EVSE that the vehicle is electrically coupled to and the CMS activates the EVSE device to charge the vehicle. Method 400 proceeds to 412.

At 412, the cloud server may provide a world wide web internet experience that may be accessed via a phone application software (app) or another human/machine interface. The phone app or human/machine interface app generates a list of EVSE at the present public LocationID as determined from the vehicle GPS coordinates and data supplied via the cloud server. The list may be generated from a database of EVSE as a function of geographical location that may be stored in the cloud server. Method 400 proceeds to 414.

At 414, method 400 solicits user input to the phone or human/machine interface app for the user to select an EVSE at the present vehicle's location so that the EVSE may be activated to charge the vehicle. The cloud server may get the LocationID and EVSEIDs at a particular geographic location by soliciting the CMS for this data or from prior charging event of other vehicles. Method 400 proceeds to 416.

At 416, the cloud server submits the LocationID or EVSEID to the EVSS to generate a remote charging start request that is to be sent to the CMS. Method 400 proceeds to 418.

At 418, the EVSS submits an activation command from the cloud server to the CMS for activating the EVSE that corresponds to the LocationID or EVSEID. Method 400 proceeds to 420.

At 420, the cloud server listens for confirmation by the CMS that the EVSE at the LocationID is activated. The CMS may send a message to the cloud server to indicate that the EVSE at the location of the vehicle has been activated. Method 400 proceeds to 422.

At 422, method 400 the EVSS confirms that activation of the EVSE that is coupled to the vehicle is successful when confirmation of the same is provided by the CMS to the EVSS. Method 400 proceeds to 424.

At 424, the charge assist software of the cloud server notifies the CDS that the EVSE at the location of the EVSE MAC address and the associated LocationID/EVSEID has been successfully activated, thereby confirming the relationship between the MAC address of the EVSE and the LocationID/EVSEID stored in memory of the cloud server. Method 400 proceeds to 426.

At 426, method 400 adjusts the EVSE MAC address mapping or relationship database with the new data. In other words, method 400 enters a new EVSE MAC address and LocationID with EVSEID into the cloud server database relationship according to the EVSE MAC address retrieved from the EVSE and the LocationID/EVSEID that was used to activate the EVSE. Method 400 proceeds to exit.

In this way, method 400 receives a EVSE MAC address from an EVSE, submits the EVSE MAC address along with the vehicle's present GPS location, if there is not a LocationID with EVSEID for the specific EVSE MAC address at the vehicle's present GPS location, the plug and activate request is denied, but the user is prompted to enter a EVSE that has a LocationID with EVSEID, the cloud server requests activation of the EVSE selected by the user, if the activation is successful, the CDS updates the EVSE MAC address to a LocationID with EVSEID in the EVSE MAC address mapped database.

Referring now to FIG. 5, a flowchart of a method for time-based mapping of EVSE MAC addresses to LocationID/EVSEID is shown. The method of FIG. 5 may be at least partially implemented as executable instructions stored in controller memory in one or more of the controllers and/or cloud components of FIGS. 1 and 3. Further, the method of FIG. 5 may include actions taken in the physical world to transform operating states of one or more of the systems of FIGS. 1 and 3.

At 502, method 500 listens for a vehicle being electrically coupled to an EVSE. The EVSE sends a status to the CMS to indicate that the EVSE is in use when a vehicle is electrically coupled to the EVSE. The EVSE reports a LocationID or EVSEID to the CMS when the EVSE is in use.

At substantially the same time, the vehicle receives a MAC address from the EVSE upon the vehicle being electrically coupled to the EVSE. The vehicle sends the MAC address, the GPS location of the vehicle, and the time that the vehicle was most recently plugged into the EVSE from an unplugged state to a cloud server. Method 500 proceeds to 504.

At block 504, method 500 sends the vehicle plug-in time stamp (e.g., the time of the instant when the vehicle most recently transitioned from not being electrically coupled to the EVSE to being electrically coupled to the vehicle) and in-use status (e.g., in-use or not in-use) from an EVSE to a CMS. The CMS sends the time stamp data and in-use status along with a LocationID and an EVSEID to a location aggregator. The LocationID may include GPS coordinates corresponding to the geographical location of a group of EVSE. Method 500 proceeds to 506.

At 506, method 500 sends a time stamp (e.g., a numerical time value), MAC address of the EVSE that the vehicle is electrically coupled to, a charging alert, and vehicle GPS location from a vehicle to the cloud server. Method 500 proceeds to 508.

At 508, the CDS links or maps the EVSE MAC address to an EVSE LocationID and EVSEID according to the GPS position of the vehicle and the GPS position that is associated with a LocationID and EVSEID that were made in use when the vehicle plugged into the EVSE with the reported EVSE MAC address. For example, if a vehicle is plugged into an EVSE at 2:38 PM, the EVSE changes its status from not in-use to in-use and provides its status to the CMS along with the time that the EVSE status changed. At nearly the same time, the vehicle receives a MAC address from the EVSE and transmits the vehicle's GPS coordinates along with the EVSE MAC address and time that the vehicle was plugged into the EVSE (e.g., electrically coupled to the EVSE). The CMS passes the EVSE status, LocationID, EVSEID, and time that the EVSE became in-use to the location aggregator and CDS. The CDS matches the time that the EVSE became in-use to the time that the vehicle was plugged into the EVSE. For example, the CDS matches a LocationID and EVSEID that became in use at 2:38 PM to a vehicle that was plugged in at 2:38 PM. Once the CDS determines that a particular vehicle became electrically coupled to an EVSE at 2:38 PM and the EVSE that became in-use at 2:38, then the MAC address that the EVSE delivered to the vehicle may be associated with the LocationID and EVSEID that were supplied to the location aggregator at 2:38 PM so that the EVSE may be associated with a particular MAC address. Subsequently, when a vehicle plugs into the EVSE and receives the MAC address, the cloud server may reference the mapping of the MAC address to the LocationID and EVSEID so that the EVSE may be activated to charge a traction battery of a vehicle. It should also be mentioned that the mapping of MAC address to Location ID/EVSEID may not be based on one charging event. Rather, the mapping may be based on data over a time period, such as one week, so that the mapping may be considered to be more reliable. Method 500 proceeds to exit.

In this way, a MAC address may be mapped or associated with a LocationID and an EVSEID so that a vehicle may contact a cloud server to activate an EVSE even when the EVSE does not conform to “Plug and Charge” standards. The mapping may be applied to achieve a simplified vehicle charging procedure.

Thus, the methods of FIGS. 4 and 5 provide for a method for charging a traction battery, comprising: generating a relationship between a media access control address value and a public location identification value; and activating an electric vehicle supply equipment via referencing the relationship according to the media access control address value. In a first example, the method further comprises including an electric vehicle supply equipment identification value in the relationship. In a second example that may include the first example, the method further comprises activating the electric vehicle supply equipment via sending a location identification value and an electric vehicle supply equipment identification value to a charge management service. In a third example that may include one or both of the first and second examples, the method includes where the relationship is generated via a cloud server. In a fourth example that may include one or more of the first through third examples, the method includes where the media control address is a media control address of an electric vehicle supply equipment device. In a fifth example that may include one or more of the first through fourth examples, the method includes where the location identification value is selected via a user and a software application. In a sixth example that may include one or more of the first through fifth examples, the method includes where activating the electric vehicle supply equipment includes sending a request from a cloud server to a charge management service that may selectively activate the electric vehicle supply equipment. In a seventh example that may include one or more of the first through sixth examples, the method includes where activating the electric vehicle supply equipment allows charge to flow from the electric vehicle supply equipment to the traction battery.

The methods of FIGS. 4 and 5 also provide for a method for charging a traction battery, comprising: generating a request to activate electric vehicle supply equipment so as to deliver electric charge to a vehicle in response to a mapping of an electric vehicle supply equipment media access control address value to a location identification value based on timing of electric vehicle supply equipment in-use status and timing of an alert that a vehicle is electrically coupled to an electric vehicle supply equipment device. In a first example, the method further comprises communicating the media access control address from the vehicle to a cloud server. In a second example that may include the first example, the method further comprises communicating the in-use status from the electric vehicle supply equipment device to the cloud server. In a third example that may include one or both of the first and second examples, the method further comprises generating the location identification value from GPS coordinates of the vehicle. In a fourth example that may include one or more of the first through third examples, the method further comprises communicating the electric vehicle supply equipment in-use status from the electric vehicle supply equipment device to the cloud server.

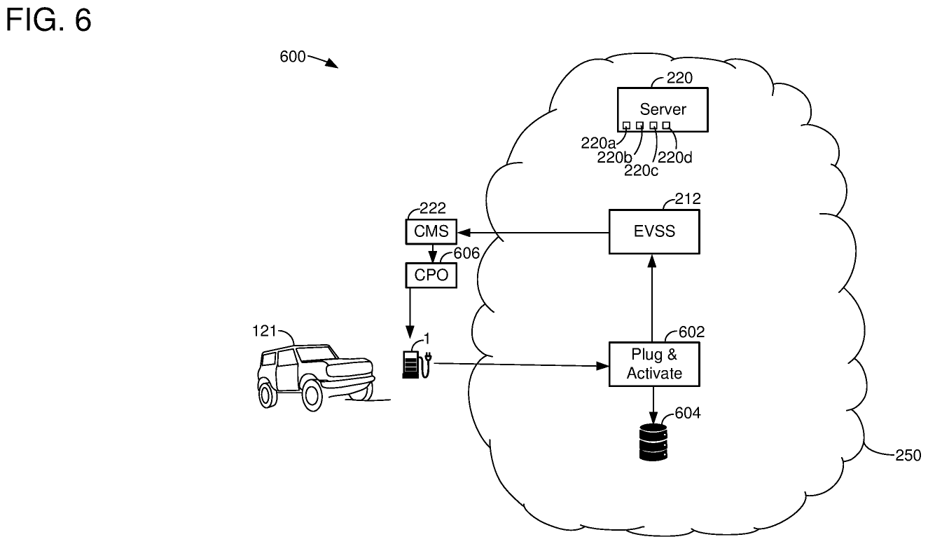

Referring now to FIG. 6, a block diagram of automated vehicle charging activation via Plug & Activate is shown. The previously mentioned cloud 250 may also include a Plug & Activate software feature that provides for automated charging of vehicle 121. The Plug & Activate feature may receive an EVSE MAC address and GPS position via a network in response to a vehicle user plugging a vehicle into an in-network DCFC. The Plug & Activate feature searches for a mapping that links the EVSE MAC address and GPS location to a LocationID that is allocated to the EVSE that was plugged into by the vehicle user. The mapping may be stored in a database 604 of a storage medium. If a mapping is found, the database 604 outputs LocationID and EVSEID. The Plug & Activate feature sends the LocationID and the EVSEID to the EVSS to request activation of the charger that is electrically coupled to the vehicle. The EVSS submits an activation command along with the LocationID and EVSEID to the CMS. The CMS submits the activation command, LocationID, and EVSEID to the CPO. The CPO lets charge flow to vehicle 121 via the charger at the LocationID and EVSEID in response to the activation command. In this way, a remote server may activate charging of a vehicle.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other vehicle hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various vehicle hardware components in combination with one or more controllers.

This concludes the description. The reading of it by those skilled in the art would bring to mind many alterations and modifications without departing from the spirit and the scope of the description.

1. A method for charging a traction battery, comprising:
generating a relationship between a media access control address value and a public location identification value; and
activating an electric vehicle supply equipment device via referencing the relationship according to the media access control address value.

2. The method of claim 1, where the relationship is further based on an electric vehicle supply equipment identification value.

3. The method of claim 1, further comprising activating the electric vehicle supply equipment device via sending the location identification value and an electric vehicle supply equipment identification value to a charge management service.

4. The method of claim 1, where the relationship is generated via a cloud server.

5. The method of claim 1, where the media access control address value is associated with the electric vehicle supply equipment device.

6. The method of claim 1, where the location identification value is selected via a user and a software application.

7. The method of claim 1, where activating the electric vehicle supply equipment device includes sending a request from a cloud server to a charge management service that may selectively activate the electric vehicle supply equipment device.

8. The method of claim 1, where activating the electric vehicle supply equipment device allows charge to flow from the electric vehicle supply equipment device to the traction battery.

9. A system, comprising:
a cloud server configured to communicate with a vehicle, an electric vehicle supply equipment, and an external charge management service, the cloud server including executable instructions that cause the cloud server to:
generate a relationship between a media access control address, a location identification value, and an electric vehicle supply equipment identification value; and
request activation of electric vehicle supply equipment according to the relationship between the media access control address, the location identification value, and the electric vehicle supply equipment identification value.

10. The system of claim 9, where the location identification value identifies a unique geographical location of electric vehicle supply equipment.

11. The system of claim 10, where the electric vehicle supply equipment identification value identifies an individual electric vehicle supply equipment device at the unique geographical location.

12. The system of claim 9, further comprising an in-vehicle human/machine interface and additional executable instructions to supply data to the in-vehicle human/machine interface so that the location identification value and the electric vehicle supply equipment identification value may be determined according to a user selection.

13. The system of claim 9, further comprising additional executable instructions that cause the cloud server to update the relationship in response to the media access control address not being associated with location identification value.

14. The system of claim 13, where the relationship is updated in response to an indication that charge is being supplied to the vehicle.

15. The system of claim 9, where activation is requested via sending a message from the cloud server to a charge management service.

16. A method for charging a traction battery, comprising:
generating a request to activate electric vehicle supply equipment so as to deliver electric charge to a vehicle in response to a mapping of an electric vehicle supply equipment media access control address value to a location identification value based on timing of electric vehicle supply equipment in-use status and timing of an alert that the vehicle is electrically coupled to an electric vehicle supply equipment device.

17. The method of claim 16, further comprising communicating the electric vehicle supply equipment media access control address value from the vehicle to a cloud server.

18. The method of claim 17, further comprising communicating the in-use status from the electric vehicle supply equipment device to the cloud server.

19. The method of claim 18, further comprising generating the location identification value from GPS coordinates of the vehicle.

20. The method of claim 19, further comprising communicating the electric vehicle supply equipment in-use status from the electric vehicle supply equipment device to the cloud server.
